(19) United States
(12) Patent Application Publication
(10) Pub. No.: US 2005/0096842 A1
(43) Pub. Date: May 5, 2005

(54) Traffic routing method and apparatus for navigation system to predict travel time and departure time

(76) Inventor: Eric Tashiro, Sherman Oaks, CA (US)

Correspondence Address: MURAMATSU & ASSOCIATES, Suite 225, 7700 Irvine Center Drive, Irvine, CA, 92618, US

(21) Appl. No.: 10/701,790

(22) Filed: Nov. 5, 2003

(51) Int. Cl. G01C 21/34

(52) U.S. Cl. 701/210; 701/204; 340/995.21

(57) ABSTRACT

A traffic routing method and apparatus for navigation system provides accurate prediction of departure and travel times by using current and past traffic incident information. The traffic routing method includes the steps of forming a database of traffic incident information which is constituted by current traffic incident data and past traffic incident data, setting a condition and priority for retrieving the traffic incident information, retrieving the traffic incident information from the database based on the condition and priority, and applying the retrieved traffic incident information to a route to a destination and calculating a predicted travel time and a departure time.

### FIELD OF THE INVENTION

This invention relates to a method and apparatus for navigation system, and more particularly, to a traffic routing method and apparatus for use in a navigation system which is capable of predicting a travel time and a departure time based on past and present traffic information such as traffic incidents, histories of traffic incidents, distances from traffic incident, weather, time, road conditions, etc.

### BACKGROUND OF THE INVENTION

A navigation system performs travel guidance for enabling a user to easily and quickly reach the selected destination. A typical example is a vehicle navigation system where a navigation system is equipped in a vehicle to assist a user (driver) to smoothly travel to the destination. Such a navigation system detects the position of the user or user's vehicle, reads out map data pertaining to an area at the current vehicle position from a data storage medium, for example, a CD-ROM (compact disc read-only memory), a DVD (digital versatile disc), or a hard disc. Alternatively, such map data can be provided to the user from a remote server through a communication network such as Internet.

When a destination is set, the navigation system starts a route guidance function for setting a guided route from the start point to the destination. To determine the guided route to the destination, the navigation system calculates and determines an optimum route to the destination based on various parameters. For example, the guided route is determined based on the shortest way to reach the destination, the route preferring freeways to local streets, the least expensive way to the destination, or the route without using toll road, and the like.

During the route guidance, the navigation system reads the nodes data from the data storage medium such as DVD and successively stores the nodes data of road segments (expressed in longitude and latitude) constituting the guided route in a memory. In the actual traveling, the node series stored in the memory is searched for a portion of the guided route to be displayed in a map display area of the monitor screen, and the portion of the guided route is highlighted so as to be discriminable from other routes. When the vehicle is within a predetermined distance of an intersection it is approaching, an intersection guidance diagram (an enlarged or highlighted intersection diagram with an arrow indicating the direction in which the vehicle is to turn at the intersection) is displayed to inform a user of the desired one of roads or directions selectable at the intersection. Such route guidance by the navigation system is also given by voice instruction.

Typically, during the route guidance, a navigation system shows a current time and an estimated arrival time. FIGS. 1A-1H show an example of operations in the route guidance mode of the conventional navigation system showing the current time and arrival time. In FIG. 1A, the navigation system displays a “Confirm Destination” screen 11 for the user to confirm his destination. If the user selects “OK to Proceed” menu on this screen, the navigation system calculates and determines a route to the destination based on the predetermined method. If the user wants other preference, he can choose an “Option” menu.

The navigation system displays a “Customized Route Options” screen 12 such as shown in FIG. 1B which prompts the user to select one of the route calculation methods. In this example, the user selects the “Maximize Freeways” method in FIG. 1B. The navigation system calculates the route based on the maximize freeway method in the route calculation screen 12 as shown in FIG. 1C. After the calculation, the navigation system displays a “Destination Map” screen 14 as shown in FIG. 1D which illustrates an entire route to the destination.

During the route guidance, by approaching every intersection to turn, the navigation system automatically displays intersection zoom screens 15-18 such as shown in FIGS. 1E-1H. In FIG. 1E, the screen 15 shows that the vehicle is running on “Main Street” and will turn at the next intersection with “Lawlence Avenue”. The screen 15 also shows that the present time (Time) is “14:26”, an estimated arrival (AT) is “14:58”, the distance to the destination (Dest) is “24.2 miles”, and the distance to the next intersection (JCT.) is “100 feet”.

In FIG. 1F, the screen 16 shows that the vehicle is approaching “Freeway 105”. The estimated arrival time (AT) is updated to “15:05” rather than “14:58” of FIG. 1E because of traffic congestion on “Lawrence Avenue”. In FIG. 1G, the screen 17 shows that the vehicle is approaching an intersection with “Carson St”. The estimated arrival time (AT) is updated to “15:28” rather than “15:05” of FIG. 1F because of the slow traffic condition on the freeway. The screen 18 in FIG. 1H shows a display example when the vehicle just reaches the destination. It shows that the vehicle has arrived at “15:30”. Thus, the vehicle actually arrived at the destination after a 32 minute delay from the originally estimated arrival time “14:58”.

In this manner, the navigation system in the conventional technology frequently updates the estimated arrival time (AT) using the current vehicle speed and the latest distance to the destination. However, it is not possible to accurately estimate the arrival time because the arrival time is calculated by a simple formula using only parameters such as the current vehicle speed and the remaining distance to the destination. Thus, an arrival time estimated when the user starts the travel may be greatly different from the actual arrival time if an accident or other traffic incidents occur on the route.

Thus, for example, if a user has an important appointment at the destination, he cannot easily determine a departure time using the estimated arrival time calculated by the conventional navigation system. The estimated arrival time calculated in the conventional navigation system is not able to predict an accurate arrival time for the destination because it is not designed to use the current and past traffic incident data. If the navigation system is able to predict the travel time more accurately, the user could use the predicted travel time to determine the departure time. Therefore, there is a need for a new method and apparatus for navigation systems for accurately estimating a travel time and predicting a departure time while taking various traffic information into consideration.

### SUMMARY OF THE INVENTION

It is, therefore, an object of the present invention to provide a navigation system which can predict a departure time and travel time more accurately when a user specifies a destination.

It is another object of the present invention to provide a navigation system which retrieves current traffic incident data and past traffic incident data and applies the retrieved data to the route to the destination, thereby accurately predicting a departure time and a travel time.

It is a further object of the present invention to provide a navigation system which retrieves the traffic incident data in accordance with the conditions and priorities preset by the user to predict a departure time and travel time more accurately.

It is a further object of the present invention to provide a navigation system which is able to provide two or more routing options to the destination based on the traffic incident information retrieved in accordance with the conditions and priorities preset by the user.

In order to achieve the above object, the navigation system receives traffic incident information from a remote traffic incident data server. Such traffic incident information is stored in a storage media as a raw traffic incident list (TIL) and frequently updated by frequently downloading the current information. Thus, the navigation system is able to utilize the current traffic incident data from the data server as well as the past traffic incident data accumulated in the navigation system.

Once a route to the destination is specified, the navigation system selects traffic incidents within a predetermined distance from the route, for example, 1 mile from the route, and further extracts traffic incidents during a predetermined time period, such as one month. Then, the navigation system filters the selected traffic incidents with the conditions and priorities specified by the user. Applying a traffic speed and distance data of each incident and considering the same or similar incident on the same or similar locations on the route, the navigation system is able to accurately estimate travel times corresponding to departure times and displays them on a screen.

More specifically, the traffic routing method in the present invention includes the steps of: forming a database of traffic incident information which is constituted by current traffic incident data and past traffic incident data; setting a condition and priority for retrieving the traffic incident information; retrieving the traffic incident information from the database based on the condition and priority; and applying the retrieved traffic incident information to a route to a destination and calculating an anticipated travel time and a departure time.

The traffic routing method further includes a step of producing one or more routing options to the destination where the anticipated travel time and departure time are created for each of the routing options. The number of routing options is selected by the user.

In the traffic routing method, the step of forming the database of traffic incident information includes a step of receiving traffic incident information from a remote data server through a wireless communication network or a public communication network and storing the traffic incident information in a memory.

The step of setting the conditions and priority includes a step of specifying an area along the route to the destination for retrieving the traffic incident information where the area is defined by a transversal distance from the route to the destination. Further, the step of setting the conditions and priority includes a step of specifying a past time range for retrieving historical traffic incident information on a traffic incident which is the same or similar to a current traffic incident at a location same or similar to that of the current traffic incident.

The step of setting the conditions and priority includes a step of specifying a type of incident for retrieving traffic incident information from the database by selecting a type of traffic incident out of an accident, non-accident, weather, or time of incident. Further, the step of setting the conditions and priority includes a step of specifying a departure time range and/or a time interval between two or more departure times.

Another aspect of the present invention is a traffic routing apparatus for a navigation system. The traffic routing apparatus is constituted by various means for achieving the routing method described above which produces estimated travel times and departure times to the destination by evaluating the current traffic information as well as the past traffic information.

According to the present invention, the navigation system is able to provide a departure time and a travel time with high accuracy. The navigation system receives traffic incident information from a remote traffic incident data server and accumulates the information. Thus, the navigation system retrieves the current traffic incident data and the past traffic incident data and applies the retrieved data to the route to the destination, thereby accurately predicting a departure time and a travel time. The navigation system is able to provide two or more routing options to the destination based on the traffic incident information retrieved in accordance with the conditions and priorities preset by the user. Thus, the user can easily determine a departure time and route in accordance with his schedule or preference. By selecting an appropriate departure time and route, the user is able to arrive the destination around the anticipated arrival time.

### BRIEF DESCRIPTION OF THE DRAWINGS

FIGS. 1A-1H are schematic diagrams showing an example of process and display screens in the route guidance mode of the conventional navigation system showing an estimated arrival time to the destination.

FIG. 2 is a block diagram showing an example of structure in a vehicle navigation system for implementing the traffic routing method and apparatus of the present invention.

FIG. 3 is a functional block diagram showing a basic structure of the traffic routing apparatus of the present invention and a remote traffic incident data server.

FIG. 4 is a diagram showing a basic operational flow for selecting conditions and priorities for retrieving traffic incident information for predicting a departure time in accordance with the present invention.

FIGS. 5A-5E are schematic diagrams showing an example of process and display screens for setting a number of routing options in the traffic routing method and apparatus of the present invention.

FIGS. 6A-6E are schematic diagrams showing an example of process and display screens for setting a type of routing in the traffic routing method and apparatus of the present invention.

FIGS. 7A-7E are schematic diagrams showing an example of process and display screens for setting priorities for retrieving traffic information in the traffic routing method and apparatus of the present invention.

FIGS. 8A-8D are schematic diagrams showing an example of process and display screens for setting a range of hit list sensitivity for retrieving traffic information in the traffic routing method and apparatus of the present invention.

FIGS. 9A-9D are schematic diagrams showing an example of process and display screens for setting a history range for retrieving traffic information in the traffic routing method and apparatus of the present invention.

FIGS. 10A-10D are schematic diagrams showing an example of process and display screens for setting a time range of departure time and a time interval between two or more departure times in the traffic routing method and apparatus of the present invention.

FIGS. 11A-11H are schematic diagrams showing an example of process and display screens for displaying two or more departure times and travel times as well as routing options based on the traffic incident information retrieved in the traffic routing method and apparatus of the present invention.

### DETAILED DESCRIPTION OF THE INVENTION

In order to provide recommendable routings and to predict travel times and departure times on the routings more accurately, the navigation system in the present invention receives most recent traffic incident information as well as keeps track of past traffic incident information such as in a weekly or monthly basis. Thus, the traffic incident information used in the present invention is frequently updated. Here, the traffic incident information includes information on traffic accidents and non-accidents, distances from traffic incidents, traffic speed, weather, time, road conditions, etc. The traffic routing method and apparatus of the present invention provides means for a user to setup various conditions for prioritizing or filtering the traffic information to achieve a desired way of determining a travel time and departure time.

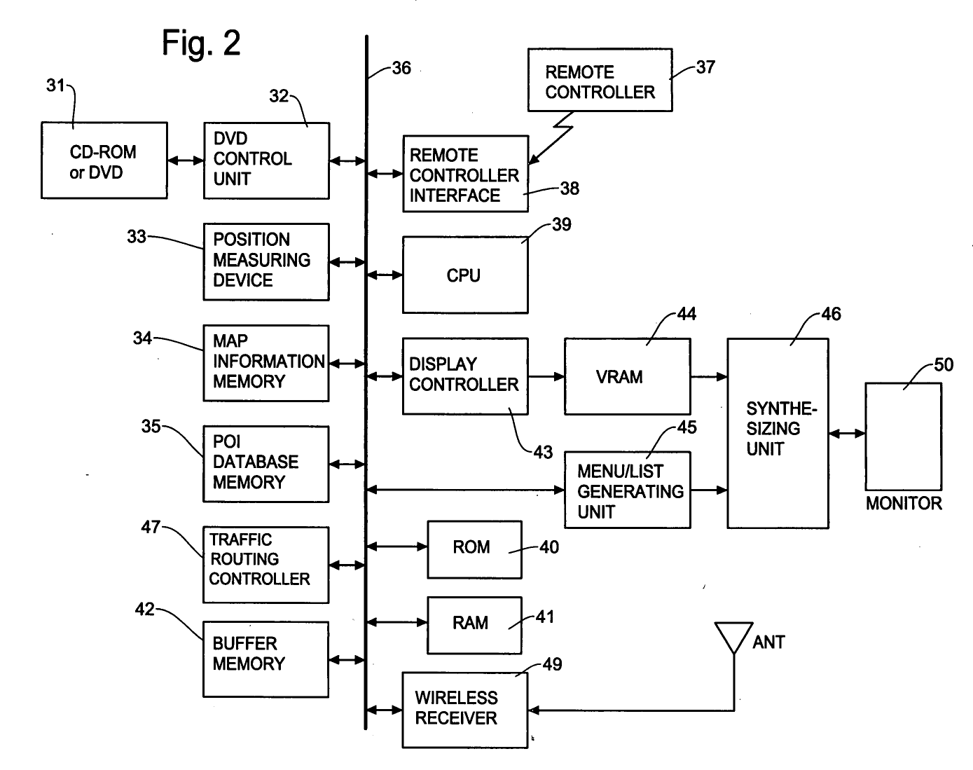

FIG. 2 is a block diagram showing an example of structure of a vehicle navigation system implementing the present invention. While a vehicle navigation system is explained for an illustration purpose, the present invention can also be applied to other types of navigation system. For example, the present invention can be advantageously used in a portable navigation device such as a one implemented in a PDA (personal digital assistant) device, a lap-top computer, or other hand-held devices.

The navigation system includes a map storage medium 31 such as a CD-ROM, DVD, hard disc or other storage means (Hereafter “DVD”) for storing map information, a DVD control unit 32 for a controlling an operation for reading the map information from the DVD, a position measuring device 33 for measuring the present vehicle position. The position measuring device 33 has a vehicle speed sensor for detecting a moving distance, a gyroscope for detecting a moving direction, a microprocessor for calculating a position, a GPS receiver, and etc.

The block diagram of FIG. 2 further includes a map information (data) memory 34 for storing the map information which is read out form the DVD 31, a database memory 35 for storing database information such as point of interest (POI) information which is read out from the DVD 31, a remote controller 37 for executing a menu selection operation, an enlarge/reduce operation, a destination input operation, etc. and a remote controller interface 38.

The navigation system further includes a bus 36 for interfacing the above units in the system, a processor (CPU) 39 for controlling an overall operation of the navigation system, a ROM 40 for storing various control programs such as a route search program and a map matching program necessary for navigation control, a RAM 41 for storing a processing result such as a guide route, a voice interface and guiding unit 42 for voice communication interface and spoken instructions, a display controller 43 for generating map image (a map guide image and an arrow guide image) on the basis of the map information, a VRAM (Video RAM) 44 for storing images generated by the display controller, a menu/list generating unit 45 for generating menu image/various list images, a synthesizing unit 46, a monitor (display) 50 and a key and screen interface 49 for interfacing with various other input means such as hard keys and joystick on a display panel of the navigation system, and the like.

A traffic routing controller 47 performs the essential function of the present invention for providing recommendable routings to the destination and predicting the departure time and travel time to the destination. The traffic routing controller 47 predicts such times by evaluating various traffic information stored in a buffer memory 42 and the map data from the memory 34 and the position data from the position measuring device 33. The traffic information will be supplied from a traffic incident data server directly through a wireless receiver 49 and an antenna or indirectly through public communication networks. As noted above, the map information and POI data are extracted from the DVD 31 and stored in the memory.

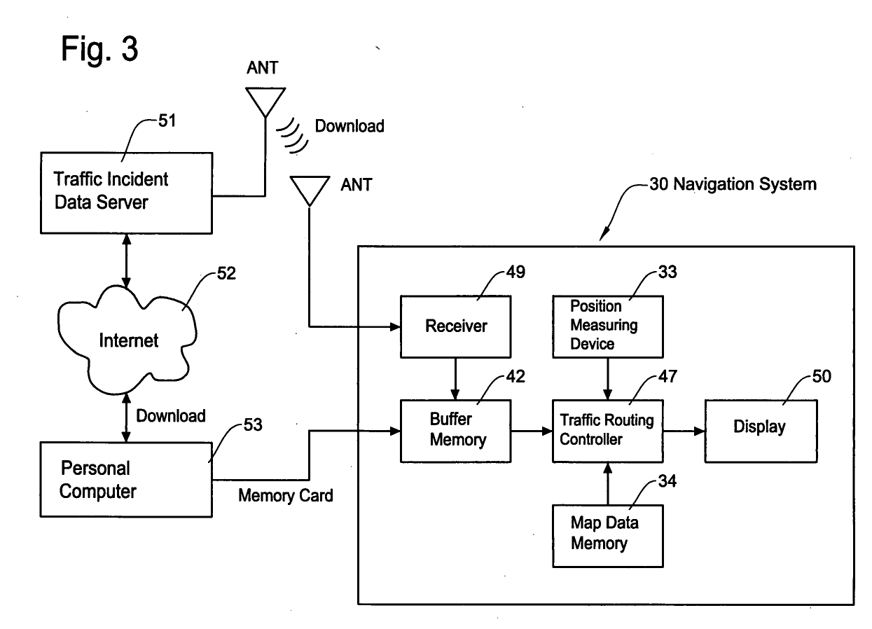

FIG. 3 is a functional block diagram showing an example of basic structure of the traffic routing apparatus of the present invention. The structure of FIG. 3 is illustrated by the components in the block diagram of FIG. 2 that are directly related to the operation of the present invention. The major components in the navigation system includes the position measuring device 33, traffic routing controller 47, map data memory 34, buffer memory 42, receiver 49, and display 50. The traffic routing controller 47 can be implemented by the CPU 39 in FIG. 2 or by a separate controller such as a microprocessor.

As shown in FIG. 3, the navigation system 30 constantly retrieves the traffic incident information from a traffic incident data server 51 through a wireless communication network. An example of such wireless communication data services includes an FM radio data service and a satellite radio data service. The traffic incident information is received through the antenna ANT and the receiver 49 and is downloaded in the buffer memory 42. Alternatively, a personal computer 53 downloads the traffic incident information from the traffic incident data server 51 through a public communication network such as Internet 52. Then, the downloaded data is copied in the buffer memory 42 by means of a storage device, such as a memory card. Thus, the database in the buffer memory 42 is constituted by the current traffic incident information as well as the past traffic incident information.

The traffic routing controller 47 extracts traffic information from the buffer memory based on the conditions and priorities established by the user. The traffic routing controller 47 applies the extracted traffic incident information to the route to the destination and calculates the travel times for different departure times. To do this, the traffic routing controller 47 also utilizes the position data from the position measuring device 33 and the map data from the map data memory 34. Typically, the navigation system displays predicted travel times and the departure times for the route to the destination or optional routes to the destination.

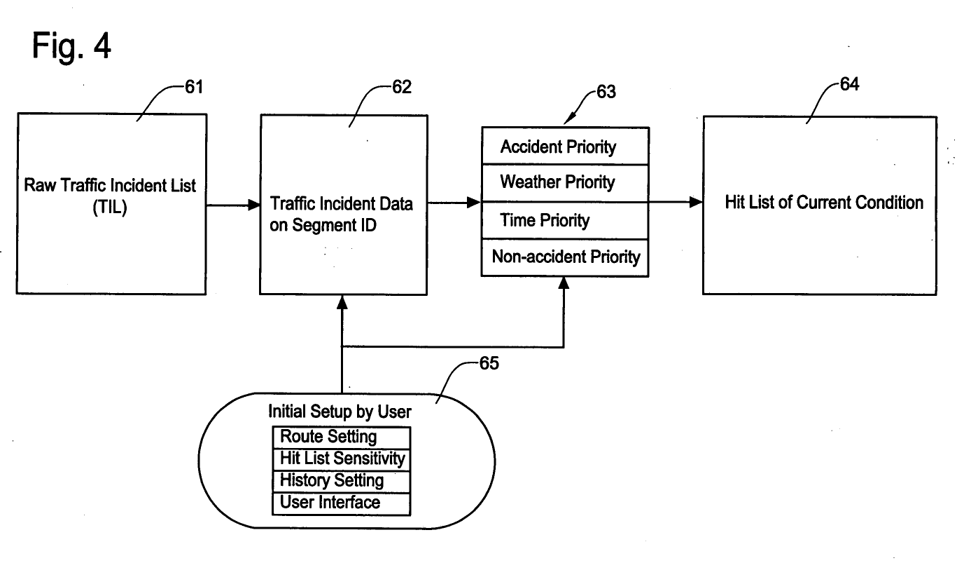

FIG. 4 shows a data extraction process and data structure for retrieving the traffic incident information based on the conditions and priorities specified by the user. From the traffic incident data server 51 (FIG. 3), the navigation system downloads the traffic incident information which is stored in the buffer memory 42. In FIG. 4, such traffic incident information is accumulated in a list of “Raw Traffic Incident List (TIL)” 61. Thus, the TIL 61 includes the current traffic incident information as well as the past traffic incident information and functions as a data source for the traffic routing method and apparatus of the present invention.

The content of traffic incident information for each incident in the TIL 61 is typically arranged by such parameters as (a) latitude/longitude, (b) road segment ID, (c) road segment classification, (d) real time traffic speed information, (e) date/time, (f) weather conditions, (g) incident types, and (h) others. From the raw data in TIL 61, traffic incident information will be extracted in response to the various conditions, such as a particular route to the destination, priority settings, sensitivity settings, history setting, etc.

The latitude/longitude parameter provides an accurate position where the incident occurred. The road segment ID provides the road identification number which shows a shape of the road (straight or winding) associated with the incident. The road segment classification informs a type of the road such as freeways, local streets and others associated with the incident. The navigation system 30 applies the latitude/longitude parameters and road segments data to the map data so that the traffic incident information associates with the particular route to the user's destination. The real time traffic speed parameter gives a traffic speed on the road where the incident occurred. The weather condition provides a weather type such as rain, snow, icy, sunny and overcast. The incident types include accidents, non-accident such as constructions, stalled vehicle, or road closure, and other types.

When setting up the navigation system, the user defines various parameters for the navigation system to retrieve and apply the traffic incident information. An example of such parameters is shown in a block 65 which lists “Route Setting”, “Hit List Sensitivity”, “History Setting”, “User Interface” for initial setup by the user. The “Route Setting” is to filter the incident information with selected priorities, a number of routing options, and a type of routing. The “Hit List Sensitivity” is to define a distance range from the route. For example, by setting “1 mile” as a hit list sensitivity, all the traffic incident information within one mile from the route (transversal distance from the route) will be detected.

The user defines the “History Setting” which is a recency factor, such as “15 days”, “30 days”, “3 months” and etc. For example, when the user selects “30 days”, the navigation system selects traffic incidents which occurred during the last 30 days along the route to the destination. By using the “User Interface”, the user can set a time range of the departure time and a time interval between two or more departure times.

When the user specifies the destination, the navigation system creates one or more routes to the destination. Then, the navigation system extracts the traffic incident information related to the locations of the segment IDs constituting the routes to the destination. In FIG. 4, a data block 62 indicates such traffic incident data associated with the road segments constituting the route to the destination based on the “Route Setting” noted above. Because of the “Hit List Sensitivity” noted above, traffic incident information associated with the segment IDs within a predetermined distance from the roads are also included in the data block 62. Similarly, the traffic incident information in the data block 62 includes not only the current traffic incident data but also the past traffic incident data within a time range specified in the “History Setting” noted above.

The traffic incident information in the data block 62 is further filtered in response to the priority selected by the user. An example of priority items is shown in a block 63 which includes (a) accident priority, (b) weather priority, (c) time priority, and (d) non-accidents priority. During the process of traffic routing in the present invention, the user selects one or more priorities so that the traffic incident information is further narrowed down based on the selected priority. For example, if the user selects only the accident priority, the traffic incident information along the route only related to traffic accident is retrieved.

Namely, the “accident priority” is to detect the traffic incident data only related to traffic accidents, such as a type of accident, time of the accident, latitude/longitude of the accident, history of the accident, traffic speed affected by the accident, etc. The “weather priority” it to retrieve the traffic incident data related to the weather along the route to the destination. The “time priority” is to extract the traffic incident data related to a particular time, such as weekdays, weekends, morning, afternoon, evening, etc. The “non-accidents priority” is to detect the traffic incident data other than traffic accident, such as road constructions, stalled vehicle, debris, road closure, police stop, police chasing, animal walking, failure of traffic signals, temporary congestion by special local events such graduation ceremonies, music concerts and others, and includes the information such as latitude/longitude, time of the incident, traffic speed, etc.

Based on the priority conditions selected by the user, the navigation system retrieves the traffic incident data, thereby creating a hit list of current conditions in a block 64. The traffic routing controller 47 analyzes the retrieved data to estimate the travel time and departure time. During this analysis, the traffic routing controller 47 weighs the traffic data based on the historical data (ex., recovery time in the similar incident in the past), time data (ex., commuting time, lunch time, midnight, sunday), particular road structure (ex., availability of convenient detour), etc. Thus, the traffic speed, recovery time, and road distance data of each incident are modified by the weighted values. The navigation system calculates estimated travel times for different departure times using the modified data. When the navigation system provides two or more routing options, such a departure time and a travel time will be provided for each route to the destination.

A simple example of predicting departure and travel times in the present invention is described here. It is assumed that the hit list sensitivity is “1 mile”, the history setting is “30 days”, and the accident priority is selected, and a route to the destination is already established. The traffic incident list (TIL) 61 shows an traffic incident which occurred ten days ago on the route at the intersection of I-405 and I-10 going on I-405 north in which a truck is overhauled at 4:00 p.m. which causes traffic backup of 5 miles per hour in a 65 miles per hour freeway. At 5:00 p.m., the traffic speed increases to 15 miles per hour. At 6:00 p.m., the traffic speed changes to 35 miles per hour. At 7:00 p.m., the traffic speed is improved to 55 miles per hour. The traffic is completely recovered at 8:00 p.m.

If a similar accident occurs in a similar location at a similar time on the route to the destination, a driver should wait four hours before passing the accident site. The navigation system provides two or more departure times each being accompanied by an estimated travel time. For the above example, the navigation system shows a departure time of four hour later where a user can enjoy the shortest travel time. Typically, in the present invention, the navigation system provides other departure time as well, such as, at present, one hour later, two hours later, etc. along with the estimated travel time corresponding to the departure time.

Such travel times are estimated by the following manner. For instance, in the above traffic incident, assuming the travel distance to the destination is 20 miles (local street 5 miles, freeway 15 miles), and the traffic incident affects 4 miles along the route, and no other traffic incident is recorded on the route to the destination. The navigation system calculates estimated travel times as follows:
(1) For a departure time 4:00 p.m.; trafficked freeway (4 miles, 5 miles/h)=48 min un-trafficked freeway (11 miles, 65 miles/h)=10 min local street (5 miles, 35 miles/h)=8.6 min five intersections (2 min per intersection)=10 min Grand total=76.6 min
(2) For a departure time 5:00 p.m.; trafficked freeway (4 miles, 15 miles/h)=16 min un-trafficked freeway (11 miles, 65 miles/h)=10 min local street (5 miles, 35 miles/h)=8.6 min five intersections (2 min per intersection)=10 min Grand total=44.6 min
(3) For a departure time 6:00 p.m.; trafficked freeway (4 miles, 35 miles/h)=6.9 min un-trafficked freeway (11 miles, 65 miles/h)=10 min local street (5 miles, 35 miles/h)=8.6 min five intersections (2 min per intersection)=10 min Grand total=35.5 min
(4) For a departure time 7:00 p.m.; trafficked freeway (4 miles, 55 miles/h)=4.4 min un-trafficked freeway (11 miles, 65 miles/h)=10 min local street (5 miles, 35 miles/h)=8.6 min five intersections (2 min per intersection)=10 min Grand total=33 min

Based on the above calculation, the navigation system displays the departure times and corresponding travel times. In the above example, there is not a significant difference in the travel time between the departure times of 6:00 p.m. and 7:00 p.m. Thus, if the user needs to get to the destination before 6 p.m. but does not want to drive for over an hour, the departure time of 5:00 p.m. may be the best option. The foregoing is a simple example produced here for an illustration purpose. In an actual application, other routing and incidents information need to be evaluated such as weather condition, season of year, construction, etc.

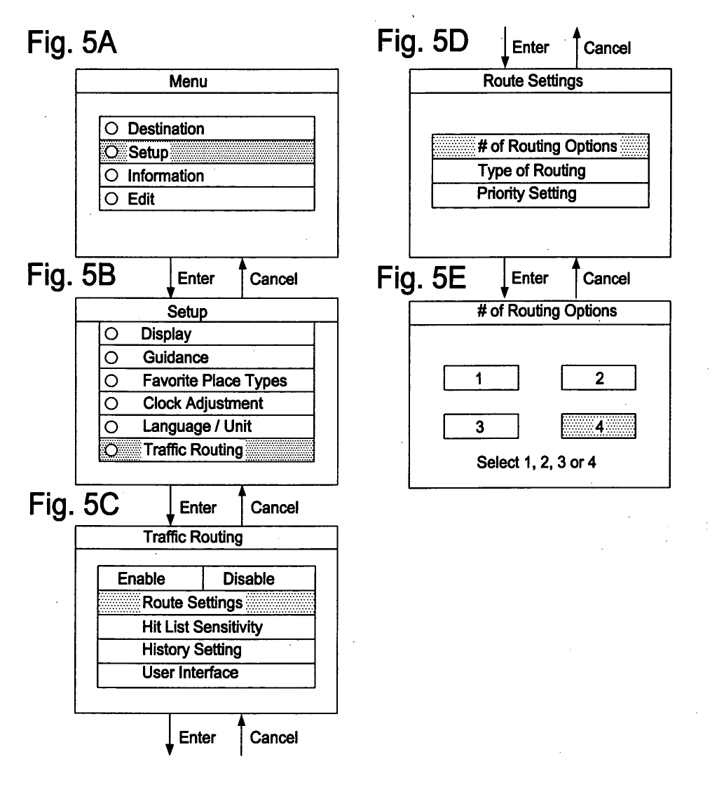

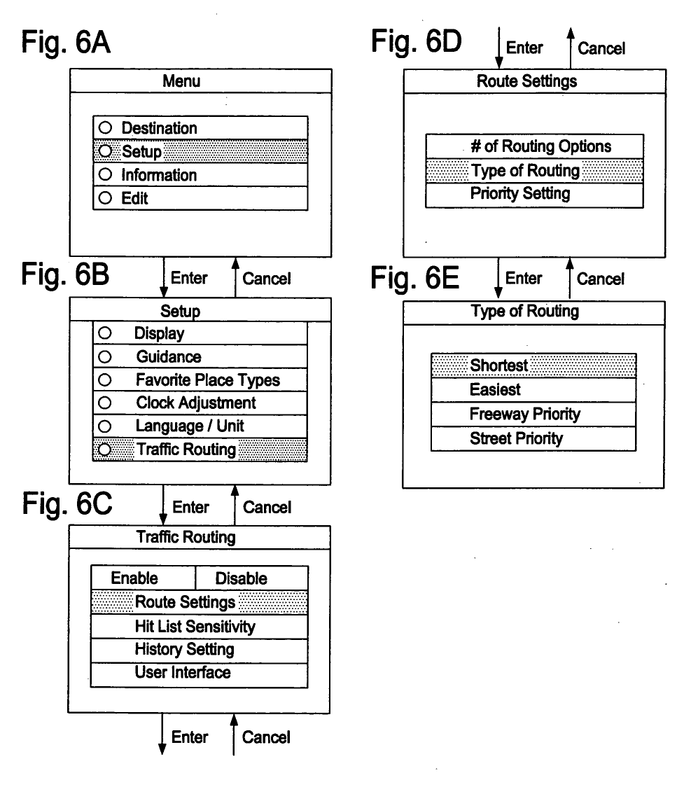

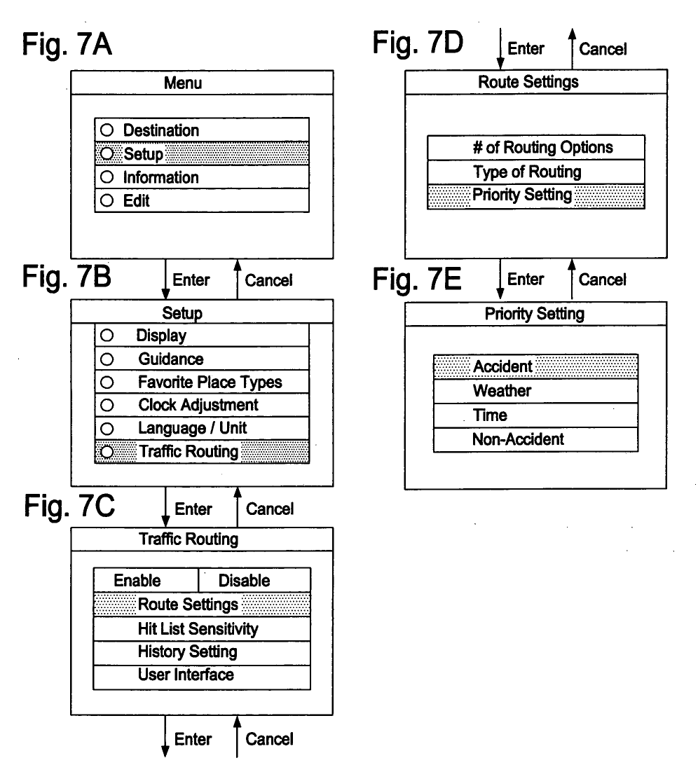

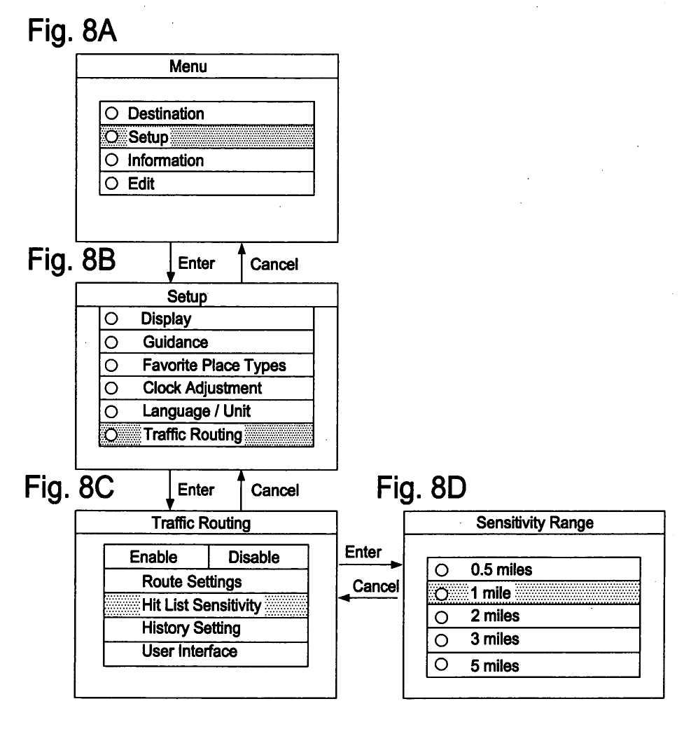

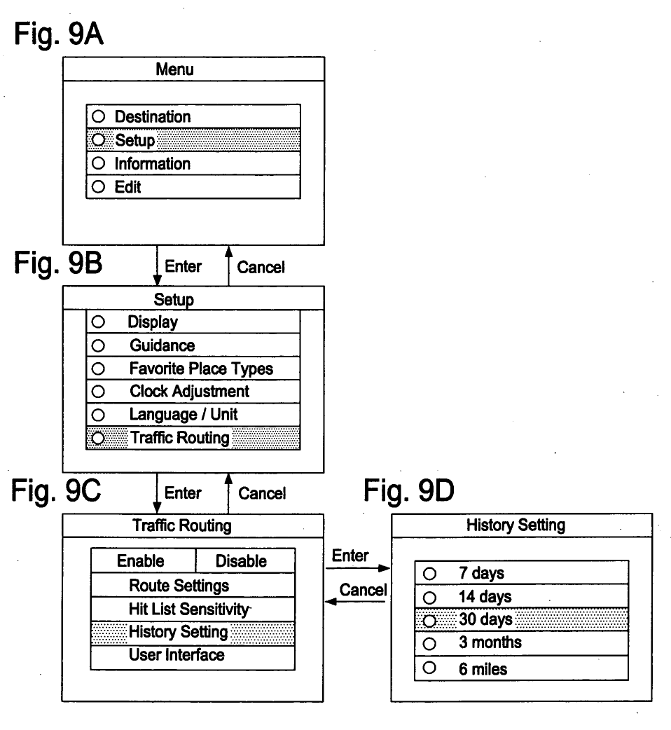

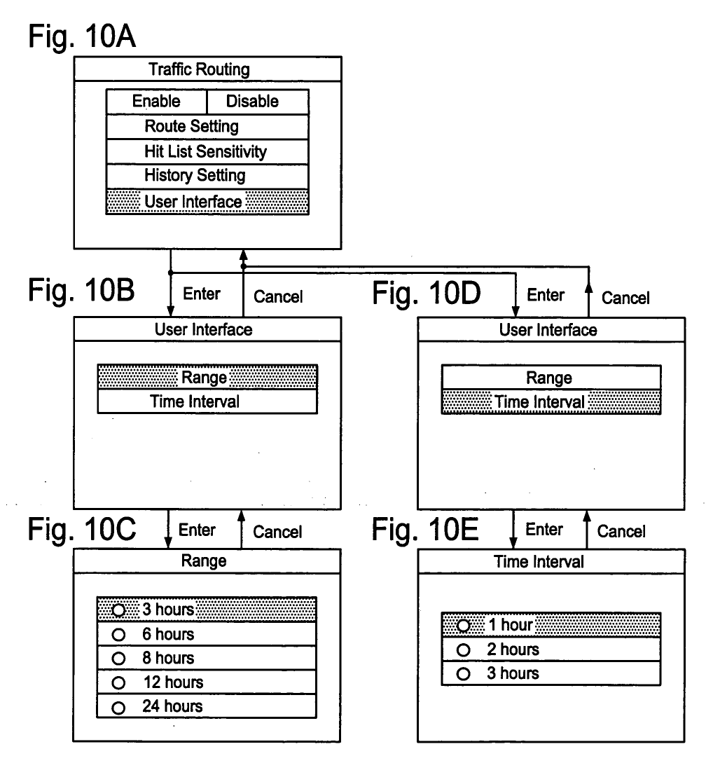

An example of process and display screen for initial setup in the navigation system of the present invention will be described with reference to FIGS. 5A-5E, 6A-6E, 7A-7E, 8A-8D, 9A-9D, and 10A-10E. FIGS. 5A-5E show an initial setup process for setting a number of routing options in the navigation system. FIGS. 6A-6E show an initial setup process for setting a type of routing in the navigation system. FIGS. 7A-7E show an initial setup process for setting priorities for retrieving traffic information. FIGS. 8A-8D show an initial setup process for setting hit list sensitivity for retrieving traffic information. FIGS. 9A-9D show an initial setup process for setting history (past time length) for retrieving traffic information. FIGS. 10A-10E show an initial setup process for setting a time range and a time interval of departure times.

For setting the number of routing options in FIGS. 5A-5E, first, the user selects a “Menu” screen as shown in FIG. 5A to setup the navigation system. By selecting a “Setup” menu, the items for setup for the navigation system are displayed as shown in FIG. 5B. Then, by selecting “Traffic Routing”, the navigation system displays a list of items for the initial setup for performing the traffic routing as shown in FIG. 5C.

The “Traffic Routing” screen of FIG. 5C includes “Enable, Disable”, “Route Setting” “Hit List Sensitivity” “History Setting” and “User Interface” menus. If the user does not want the traffic routing function, he can disable this function by selecting “Disable” menu. If the “Route Setting” menu is selected in FIG. 5C, the “Route Setting” screen is displayed as shown in FIG. 5D. The “Route Setting” screen includes “Number of Routing Options” for setting a number of routes to a destination, “Type of Routing” for setting a type of method for selecting a route, and “Priority Setting” for setting one or more priorities for retrieving the traffic incident data. When the user selects the “Number of Routing Options”, the navigation system prompts the user to select a desired number of routes such as 1, 2, 3 or 4 as shown in FIG. 5E.

In setting the type of routing in FIGS. 6A-6E, the process shown in FIGS. 6A-6C are the same as that of FIG. 5A-5C for selecting the initial setup of traffic routing. In the “Traffic Routing” screen of FIG. 6C, the user selects the “Route Setting” menu. Then, the navigation system displays the “Route Setting” screen which lists route setting methods as shown in FIG. 6D. The route setting method includes “Number of Routing Options”, “Type of Routing”, and “Priority Setting”.

When the user selects the “Type of Routing”, the navigation system displays a screen of FIG. 6E listing types of routing method to prompt the user to select one of the methods. The list includes a “Shortest” method in which the navigation system finds the shortest route to the destination, an “Easiest” method in which the navigation system determines the easiest route to the destination, a “Freeway Priority” in which the navigation system finds a route preferring freeways, and a “Street Priority” in which the navigation system finds a route to the destination preferring local streets.

In setting the priority items in FIGS. 7A-7E, the process of FIGS. 7A-7C are the same as those of FIG. 5A-5C for selecting the initial setup of traffic routing. In the “Traffic Routing” screen of FIG. 7C, the user selects the “Route Setting” menu. Then, the navigation system displays the “Route Setting” screen which lists route setting methods as shown in FIG. 7D. The route setting method includes “Number of Routing Options”, “Type of Routing”, and “Priority Setting”.

When the user selects the “Priority Setting”, the navigation system displays a screen of FIG. 7E listing types of traffic incident as priority items to prompt the user to select one or more of the incident types. The list includes “Accident” incident in which the navigation system retrieves the traffic information concerning traffic accident, “Weather” in which the navigation system retrieves the traffic information concerning weather and road condition related to weather, “Time” in which the navigation system retrieves the traffic information concerning times of incidents, and “Non-Accident” in which the navigation system retrieves the traffic information concerning construction, stalled vehicle, traffic signal failure, police stop, debris, road closure, etc.

In setting the hit list sensitivity in FIGS. 8A-8D, the process of FIGS. 8A-8B are the same as those of FIGS. 5A-5B for selecting the initial setup for traffic routing. In the “Traffic Routing” screen of FIG. 8C, the user selects the “Hit List Sensitivity” menu. Then, the navigation system displays a “Sensitivity Range” screen which lists two or more transversal distances from the route to the destination. In other words, the “Sensitivity Range” determines a width of an area along the route to the destination to retrieve the traffic incident data. If the sensitivity range of one (1) mile is selected, the navigation system retrieves the traffic incident data occurred within one mile from the route to the destination.

In setting the history in FIGS. 9A-9D, the process shown in FIGS. 9A-9B are the same as those of FIGS. 5A-5B for selecting the initial setup for traffic routing. In the “Traffic Routing” screen of FIG. 9C, the user selects the “History” menu. Then, the navigation system displays a “History Setting” screen which lists several time lengths for setting a past time rage for retrieving the past data. In other words, the “History Setting” determines a time length toward the past to retrieve traffic incident data. Thus, for example, if the history setting by the user is “30 days”, the navigation system retrieves the data on the traffic incidents occurred on the route or around (ex. one mile from) the route to the destination within 30 days.

In setting the user interface in FIGS. 10A-10E, the user selects the “User Interface” menu on the traffic routing screen of FIG. 10A. Then, the navigation system displays a “User Interface” screen for selecting a time range and a time interval of departure times in FIG. 10B. The “Range” menu is to define a time range of departure time from the current time. The “Time Interval” is to define a time difference between two departure times.

When selecting the “Range” menu of departure times in FIG. 10B, the navigation system shows a “Range” screen which lists several different time ranges of departure times such as “3 hours”, “6 hours”, “8 hours” and the others as shown in FIG. 10C. In this example, the user selects the “3 hours” range so that the navigation system will produce one or more departure times which are within 3 hours from the current time.

When selecting the “Time Interval” menu of departure times in FIG. 10B, the navigation system shows a “Time Interval” screen which lists several time differences between departure times such as “1 hour”, “2 hours” and “3 hours” as shown in FIG. 10D. In this example, the user selects the “1 hour” time interval so that the navigation system will produce two or more departure times which are different by one hour from one another. In the above example, since the user has set the “3 hours” range in FIG. 10C, the departure times within 3 hours from the current time which are different by one hour from the others will be produced.

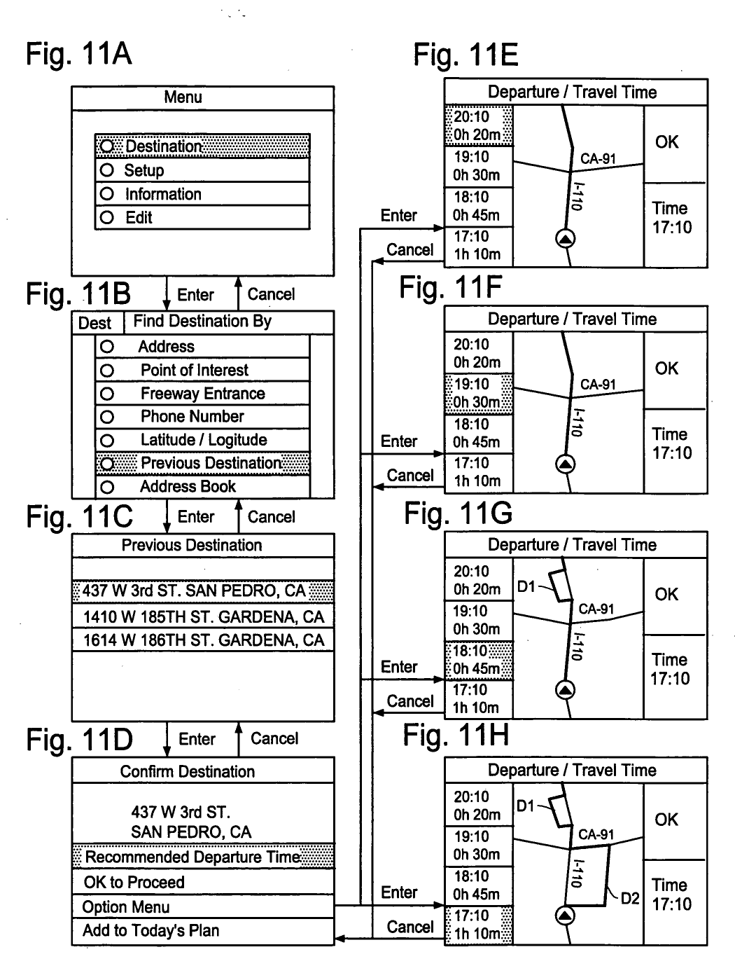

After the user completes the above initial setup, the navigation system is ready to predict departure times and travel times. FIGS. 11A-11H show an example of process and display screens for displaying two or more departure times and travel times as well as routing options based on the retrieved traffic information in the traffic routing method and apparatus of the present invention. FIGS. 11A-11C show a typical process for selecting a destination, and FIG. 11D shows a process for activating the traffic routing function of the present invention. FIGS. 11E-11H show an example of screen displays in the present invention each illustrating travel times, departure times and recommendable routes to the destination.

In the “Menu” screen as shown in FIG. 11A, the user selects the “Destination” menu. Then, the navigation system displays a “Find Destination By” screen in FIG. 11B which shows various input methods for defining the destination. In this example, the user selects the “Previous Destination” menu to specify the destination from the past destinations recorded in the navigation system. FIG. 11C is a display example of the “Previous Destination” screen in which the user selects the address “437 W 3rd ST. SAN PEDRO, Calif.” on the screen. Then, the navigation system displays a “Confirm Destination” screen as shown in FIG. 11D. In order to obtain predicted departure and travel times, the user selects a “Recommended Departure Time” menu on the screen.

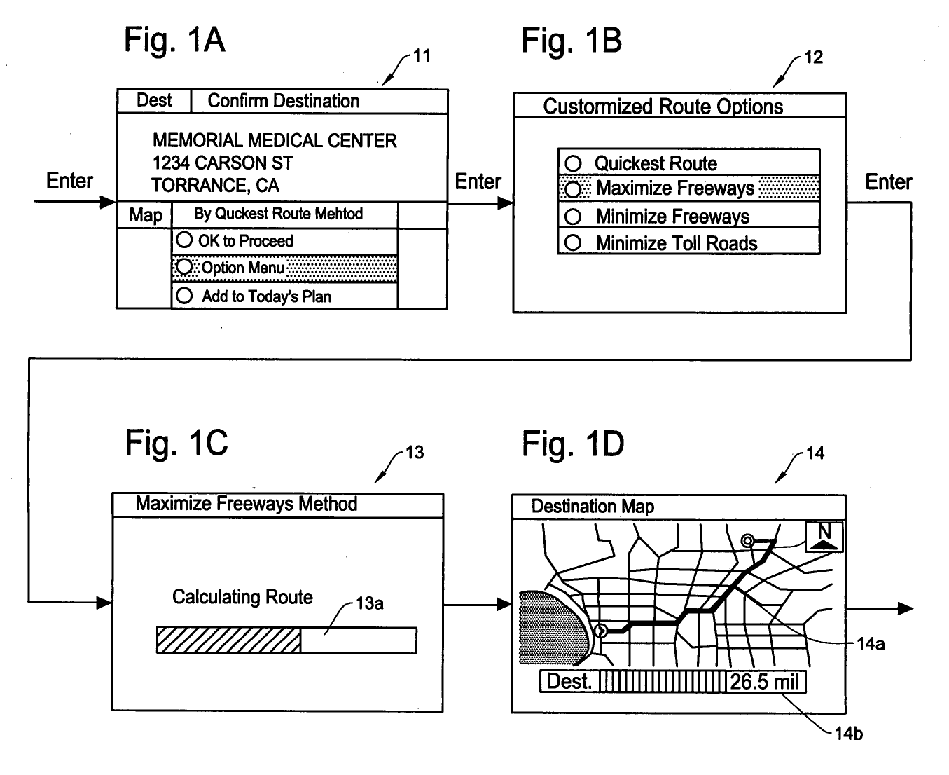

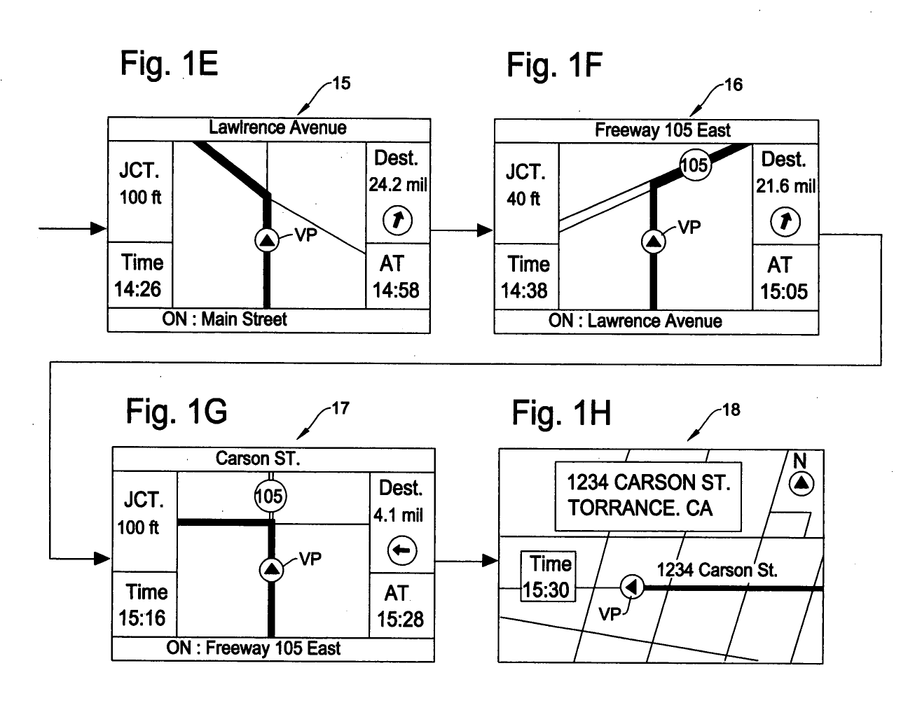

Then, the navigation system retrieves the current traffic incident information from the traffic incident data server 51 (FIG. 3). The navigation system has accumulated the past traffic incident information and created a database of historical traffic incident data. Thus, when the “Recommended Departure Time” menu is selected in FIG. 1D, the navigation system retrieves the current and past traffic incident data based on the conditions and priorities set in the navigation system through the setup procedures of FIGS. 5A-5E, 6A-6E, 7A-7E, 8A-8D, 9A-9D and 10A-10E.

If a traffic incident is detected on or around the route to the destination, the navigation system determines a travel time and a departure time based on the type of incident, time of the incident, traffic speed, past record on the same or similar incident, etc. If applicable, the navigation system will also show another route or detour to the destination based on the number of routing options preset in the system (FIGS. 5D-5E). Accordingly, the navigation system is able to provide an estimated travel time and a departure time within a time range defined by the user.

FIGS. 11E-11H show an example of “Departure/Travel Time” screen in accordance with the present invention. This example shows the situation where the destination can be easily reached through a freeway I-110 if there were no traffic incident. However, because of the traffic incident, such as an accident, on or near the freeway I-110, the traffic is extremely slowed down. Under this situation, the navigation system shows travel times and departure times, current time, routes to the destination, etc. Since the user presets the time range of “3 hours” and the time interval of “1 hour” in the setup process of FIGS. 10A-10E, the navigation system shows departure times of one hour interval within three hours from the current time.

In FIG. 11E, the navigation system predicts that if the user departs at 20:10, i.e., three hours from the current time 17:10, the travel time is only 20 minutes, because the traffic on the freeway I-110 will be completely recovered at that time. In FIG. 11F, the navigation system predicts that if the user departs at 19:10, i.e., two hours from the current time 17:10, the travel time is 30 minutes, because the traffic on the freeway I-110 will be almost, but not completely, recovered at that time.

In FIG. 11G, the navigation system predicts that if the user departs at 18:10, i.e., one hour from the current time 17:10, the travel time is 45 minutes, because the traffic on the freeway I-110 will not be recovered at that time. The navigation system also predicts that the user has to take a detour D1 to avoid the accident point on the route. In FIG. 11F, the navigation system predicts that if the user departs right now, 17:10, the travel time is one hour and 10 minutes, because the traffic situation on the freeway I-110 is extremely deteriorated and the user has to take detours D1 and D2.

As has been described in the foregoing, according to the present invention, the navigation system is able to provide a departure time and a travel time with high accuracy. The navigation system receives traffic incident information from a remote traffic incident data server and accumulates the information. Thus, the navigation system retrieves the current traffic incident data and the past traffic incident data and applies the retrieved data to the route to the destination, thereby accurately predicting a departure time and a travel time. The navigation system is able to provide two or more routing options to the destination based on the traffic incident information retrieved in accordance with the conditions and priorities preset by the user. Thus, the user can easily determine a departure time and route in accordance with his schedule or preference. By selecting an appropriate departure time and route, the user is able to arrive the destination around the predicted arrival time.

Although the invention is described herein with reference to the preferred embodiments, one skilled in the art will readily appreciate that various modifications and variations may be made without departing from the spirit and the scope of the present invention. Such modifications and variations are considered to be within the purview and scope of the appended claims and their equivalents.

1. A traffic routing method for a navigation system to predict departure and travel times, comprising the following steps of:
forming a database of traffic incident information which is constituted by current traffic incident data and past traffic incident data;
setting a condition and priority for retrieving the traffic incident information;
retrieving the traffic incident information from the database based on the condition and priority; and
applying the retrieved traffic incident information to a route to a destination and calculating a predicted travel time and a departure time.

2. A traffic routing method as defined in claim 1, further comprising a step of producing one or more routing options to the destination wherein said predicted travel time and departure time are created for each of said routing options.

3. A traffic routing method as defined in claim 1, wherein said step of forming the database of traffic incident information includes a step of receiving traffic incident information from a remote data server through a wireless communication network or a public communication network and storing the traffic incident information in a memory.

4. A traffic routing method as defined in claim 1, wherein said step of setting the conditions and priority includes a step of specifying an area along the route to the destination for retrieving the traffic incident information where the area is defined by a transversal distance from the route to the destination.

5. A traffic routing method as defined in claim 1, wherein said step of setting the conditions and priority includes a step of specifying a past time range for retrieving historical traffic incident information from the data base.

6. A traffic routing method as defined in claim 5, wherein said step of retrieving the historical traffic incident information includes a step of retrieving past traffic incident information on a traffic incident same or similar to a current traffic incident at a location same or similar to that of the current traffic incident.

7. A traffic routing method as defined in claim 2, wherein said step of producing two or more routing options to the destination includes a step of specifying a number of routing options.

8. A traffic routing method as defined in claim 1, wherein said step of setting the conditions and priority includes a step of specifying a type of incident for retrieving traffic incident information from the database.

9. A traffic routing method as defined in claim 8, wherein said step of specifying the type of incident for retrieving traffic incident information includes a step of selecting a type of traffic incident out of an accident, non-accident, weather, or time of incident.

10. A traffic routing method as defined in claim 1, wherein said step of setting the conditions and priority includes a step of specifying a departure time range or a time interval between departure times.

11. A traffic routing apparatus for a navigation system to predict departure and travel times, comprising:
means for forming a database of traffic incident information which is constituted by current traffic incident data and past traffic incident data;
means for setting a condition and priority for retrieving the traffic incident information;
means for retrieving the traffic incident information from the database based on the condition and priority; and
means for applying the retrieved traffic incident information to a route to a destination and calculating a predicted travel time and a departure time.

12. A traffic routing apparatus as defined in claim 11, further comprising means for producing one or more routing options to the destination wherein said predicted travel time and departure time are created for each of said routing options.

13. A traffic routing apparatus as defined in claim 11, wherein said means for forming the database of traffic incident information includes means for receiving traffic incident information from a remote data server through a wireless communication network or a public communication network and storing the traffic incident information in a memory.

14. A traffic routing apparatus as defined in claim 11, wherein said means for setting the conditions and priority includes means for specifying an area along the route to the destination for retrieving the traffic incident information where the area is defined by a transversal distance from the route to the destination.

15. A traffic routing apparatus as defined in claim 11, wherein said means for setting the conditions and priority includes means for specifying a past time range for retrieving historical traffic incident information from the data base.

16. A traffic routing apparatus as defined in claim 15, wherein said means for retrieving the historical traffic incident information includes means for retrieving past traffic incident information on a traffic incident same or similar to a current traffic incident at a location same or similar to that of the current traffic incident.

17. A traffic routing apparatus as defined in claim 12, wherein said means for producing two or more routing options to the destination includes means for specifying a number of routing options.

18. A traffic routing apparatus as defined in claim 11, wherein said means for setting the conditions and priority includes means for specifying a type of incident for retrieving traffic incident information from the database.

19. A traffic routing apparatus as defined in claim 18, wherein said means for specifying the type of incident for retrieving traffic incident information includes means for selecting a type of traffic incident out of an accident, non-accident, weather, or time of incident.

20. A traffic routing apparatus as defined in claim 11, wherein said means for setting the conditions and priority includes means for specifying a departure time range or a time interval between departure times.
